(19) United States
(12) Patent Application Publication
(10) Pub. No.: US 2020/0130425 A1
(43) Pub. Date: Apr. 30, 2020

(54) BEADLOCK WITH FILLER RING

(71) Applicant: Pilot Inc., City of Industry, CA (US)

(72) Inventors: David Sorrentino, City of Industry, CA (US); Kelleigh Ash, City of Industry, CA (US)

(21) Appl. No.: 16/663,108

(22) Filed: Oct. 24, 2019

Related U.S. Application Data
(60) Provisional application No. 62/751,304, filed on Oct. 26, 2018.

(51) Int. Cl. B60C 15/028; B60B 25/10

(52) U.S. Cl. CPC B60C 15/028; B60B 25/10

(57) ABSTRACT

A beadlock assembly comprises a beadlock and a separate filler ring. When installed on a wheel, the filler ring is positioned immediately adjacent the wheel, and the beadlock covers the filler ring while securing the filler ring to the wheel. Use of the filler ring enables the beadlock to comply with applicable regulations for on-road use. For off-road use, the filler ring may be removed, and the beadlock may be used to secure a bead of a tire to the wheel.

### CROSS-REFERENCE TO RELATED APPLICATIONS

This application claims priority to U.S. Provisional Patent Application No. 62/751,304, filed Oct. 26, 2018 and entitled “Beadlock with Filler Ring,” the entire disclosure of which is hereby incorporated by referenced herein.

### FIELD OF THE DISCLOSURE

The present disclosure relates to mechanical devices for securing a tire to a wheel, and more particularly to beadlocks.

### BACKGROUND

With reference to FIG. 5, a typical tire 500 comprises a tread 504, sidewalls 508, a first bead 512A, and a second bead 512B. When the tire 500 is mounted on a wheel and fully inflated, the air pressure inside the tire pushes the beads 512A and 512B against the wheel rim, securing the tire 500 in place on the wheel.

However, tires may be partially deflated to obtain certain advantages, including better traction, when traveling off-road, such as in or on sand, snow, mud, and/or rocks. The air pressure in a partially deflated tire may be insufficient to secure the tire to the wheel. In such situations, beadlocks are used to mechanically secure the bead of the tire to the wheel.

### SUMMARY

Known beadlocks may not be compliant with applicable regulations, such as those established by the U.S. Department of Transportation, as required for on-road use. The present disclosure describes a beadlock system that may be used in a DOT-compliant manner.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A shows an exploded view of a beadlock assembly in accordance with at least some embodiments of the present disclosure;

FIG. 1B shows a front elevation view of a wheel of a beadlock assembly in accordance with at least some embodiments of the present disclosure;

FIG. 1C shows a front elevation view of a filler ring of a beadlock assembly in accordance with at least some embodiments of the present disclosure;

FIG. 1D shows a rear elevation view of a beadlock of a beadlock assembly in accordance with at least some embodiments of the present disclosure;

FIG. 2A shows a perspective view of a beadlock assembly in a first configuration, in accordance with at least some embodiments of the present disclosure;

FIG. 2B shows a partial cutaway view of the beadlock assembly of FIG. 2A;

FIG. 3A shows a perspective view of a beadlock assembly in a second configuration, in accordance with at least some embodiments of the present disclosure;

FIG. 3B shows a partial cutaway view of the beadlock assembly of FIG. 3A;

FIG. 4A shows a perspective view of a beadlock assembly in accordance with at least some embodiments of the present disclosure;

FIG. 4B shows a close-up partial perspective view of the beadlock assembly of FIG. 4A;

FIG. 4C shows a close-up partial elevation view of the beadlock assembly of FIG. 4A; and

FIG. 5 shows a cross-sectional view of a tire.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

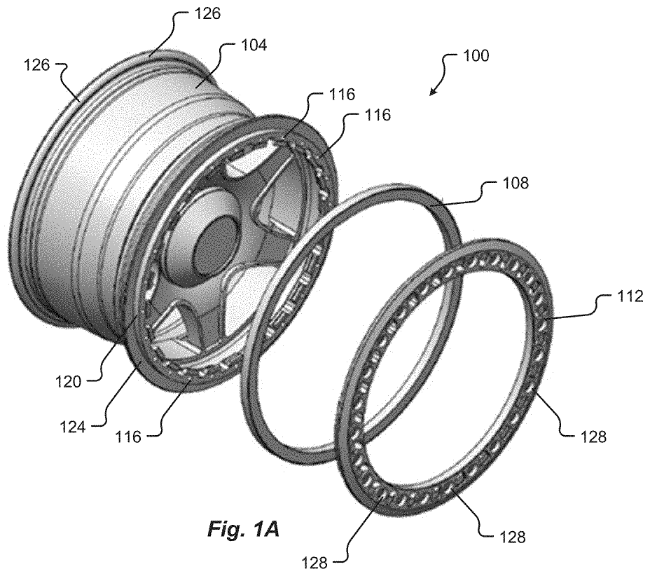

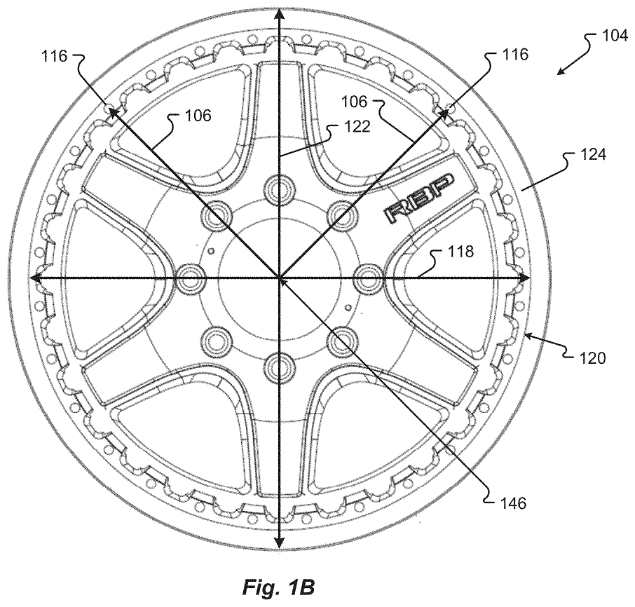

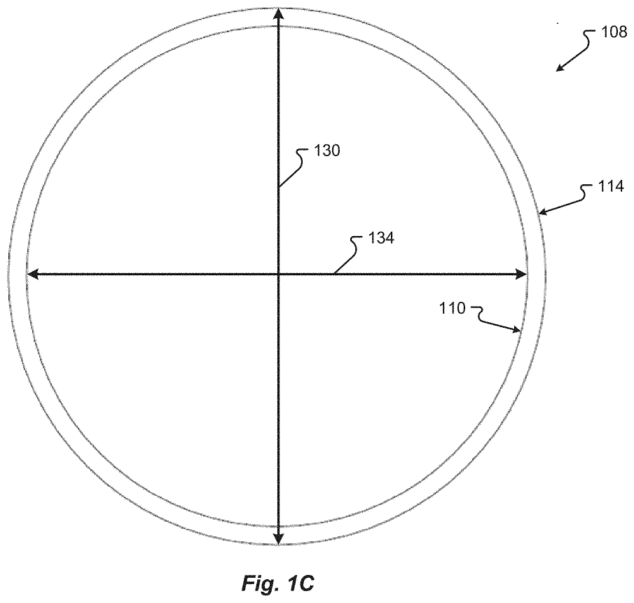

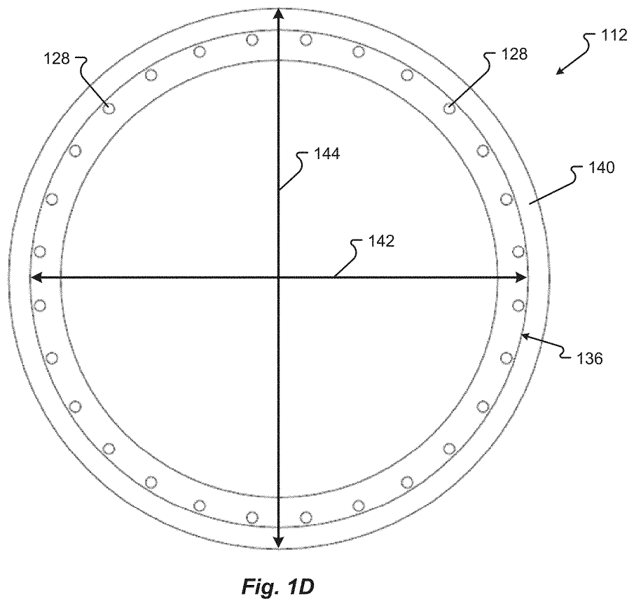

Turning first to FIGS. 1A-1D, a beadlock assembly according to embodiments of the present disclosure may comprise a wheel 104, a filler ring 108, and a beadlock 112. The wheel 104 comprises a plurality of threaded apertures 116 spaced at regular intervals and at a specific radial distance 106 from an axis 146 of the wheel 104. Each of the threaded apertures 116 is configured to receive a bolt. Although the wheel 104 is depicted as have 28 apertures 116, in other embodiments more or fewer apertures 116 may be included on the wheel 104. The wheel 104 also comprises a circumferential ledge 120 having a diameter 118, and an adjacent flange 124 having an outer diameter 122. In some embodiments, such as that shown in FIG. 1, the flange 124 is also the outer rim of the wheel 104. The wheel 104 further comprises an inner rim 126.

The filler ring 108 is ring-shaped and sized such that an inner circumference 110 thereof has a diameter 134 equal to or slightly greater than the diameter 118 of the circumferential ledge 120 of the wheel 104, so as to allow the filler ring 108 to be placed over the circumferential ledge 120. Stated differently the inner circumference 110 has a diameter 134 selected to enable the filler ring 108 to fit around the circumferential ledge 120. The outer circumference 114 of the filler ring 108 may, in some embodiments, have an outer diameter 130 that is substantially the same as the outer diameter 122 of the flange 124 of the wheel 104.

The filler ring 108 may be hollow or solid. In some embodiments, the interior of the filler ring 108 may be filled with a honeycomb structure or with some other filler that increases the strength of the filler ring 108 but without using as much material as if the filler ring 108 were solid. The filler ring may be made of metal, metal alloy, plastic, composite, or any combination thereof.

The beadlock 112 is also ring-shaped, and has an outer diameter 144 substantially the same as the outer diameter 122 of the flange 124 and as the outer diameter 134 of the filler ring 108. The beadlock 112 comprises a plurality of apertures 128 for use in bolting the beadlock 112 to the wheel 104. Although the beadlock 112 is depicted as having 28 apertures 128, in other embodiments the beadlock 112 may comprise more or fewer apertures 128. In some embodiments, the beadlock 112 may comprise other apertures (e.g., between the apertures 128) for aesthetic purposes.

As shown in the rear view of the beadlock 112 in FIG. 1D, the beadlock comprises a flange 140. In some embodiments, the beadlock 112 may further comprises a circumferential ledge 136, which may have a diameter 142 substantially equal to the diameter 118 of the circumferential ledge 120 of the wheel 104.

The beadlock 112 may be made of metal, metal alloy, plastic, composite, or any combination thereof. Where the primary purpose of the beadlock 112 is functional, the beadlock 112 may be made of a stronger material and/or may be thicker or otherwise structurally designed to have sufficient strength to hold a tire 500 to a wheel 104). Where the primary purpose of the beadlock 112 is aesthetic, the beadlock 112 may be made of a less strong material, and/or may be thinner or otherwise designed with a greater focus on aesthetics and less focus on functionality. In some embodiments, the side of the beadlock 112 that faces away from the wheel 104 during use may be provided with a specialized finish, such as a metallic finish, a polished finish, or any other desired finish, for aesthetic purposes.

Beadlock assemblies according to embodiments of the present disclosure may be assembled with or without the filler ring 108. When the beadlock 112 is not being used to secure a tire 500 to the wheel 104, the filler ring 108 is used. When the beadlock 112 is being used to secure a tire 500 to the wheel 104, the filler ring 108 is not used.

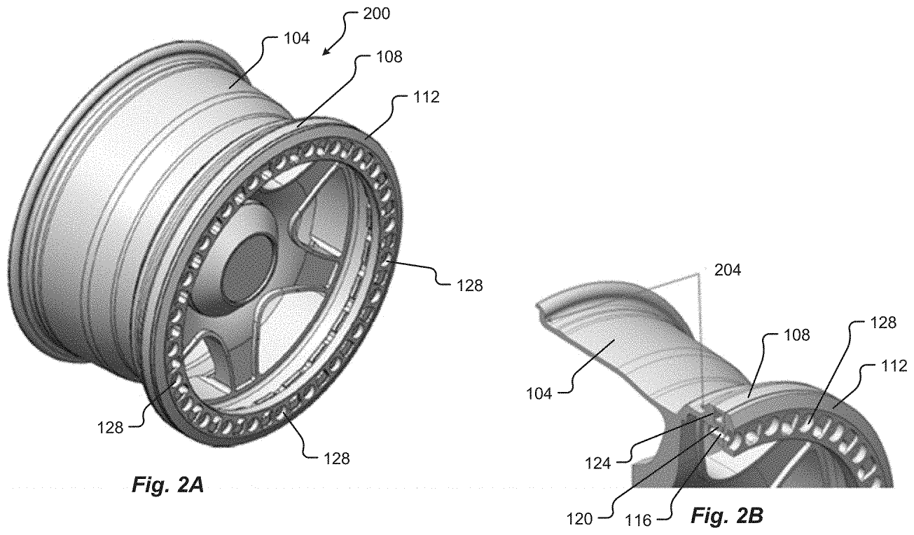

FIGS. 2A-2B show a beadlock assembly 200 using the filler ring 108. To assemble the beadlock assembly 200 in this configuration, the filler ring 108 is placed over the circumferential ledge 120 of the wheel 104, and the beadlock 112 is pressed against the wheel 104 with the bolt apertures 128 of the beadlock 112 are aligned with the threaded apertures 116 of the wheel 104. The filler ring 108 is thus sandwiched between the flange 124 of the wheel 104 and the flange 140 of the beadlock 112. Because the flange 124, the filler ring 108, and the beadlock 112 all have the same or substantially similar diameters, use of the filler ring 108 results in a relatively unbroken surface comprising the outer circumference of each of the flange 124, the filler ring 108, and the beadlock 112.

With the beadlock assembly 200 arranged in this configuration, a tire 500 is normally mounted on the wheel 104, with the internal air pressure of the tire pushing the beads 512A, 512B of the tire against the wheel 104 at the mounting locations 204.

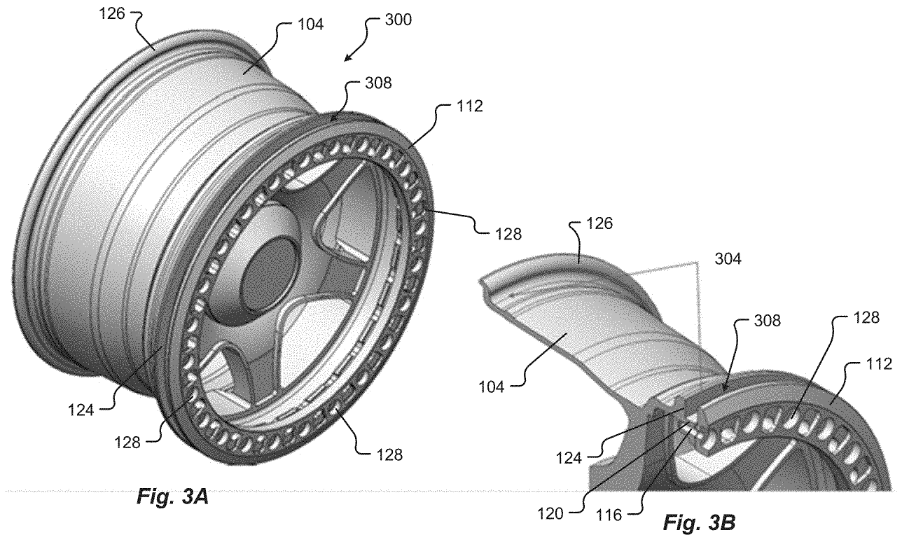

FIGS. 3A-3B show a beadlock assembly 300 assembled in the same manner as the assembly 200, but without the filler ring 108. When the filler ring 108 is not used, the flange 124 of the wheel 104, the circumferential ledge 120 of the wheel 104, and the flange 140 of the beadlock 112 define a channel 308 in which one of the beads 512A, 512B of the tire may be secured. With the beadlock assembly 300 then, one bead (e.g., the bead 512A) of the tire 500 (which may, for example, be only partially inflated) rests adjacent the inner rim 126 of the wheel 104, while the other bead (e.g., the bead 512B) of the tire 500 is secured in the channel 308. These mounting locations 304 are specifically called out in FIG. 3B.

More specifically, the width of the channel 308 (in the axial direction) is such that when the beadlock 112 is bolted to the wheel 104, the bead 512A or 512B of the tire 500 (including the portion of the tire immediately adjacent both sides of the bead 512A or 512B) is squeezed between the flanges 124 and 140, thus securing the tire 500 to the wheel 104.

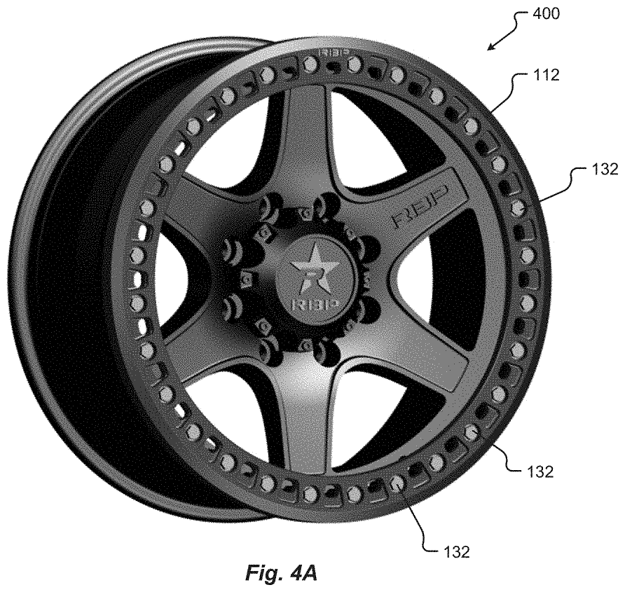

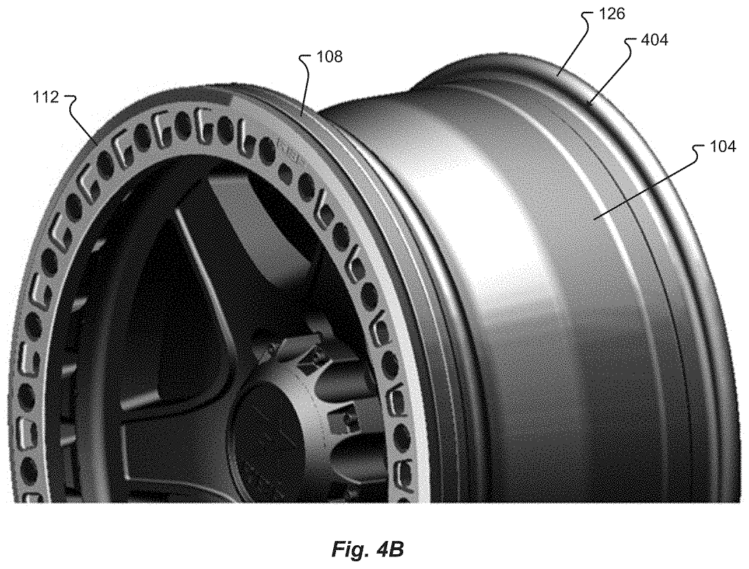

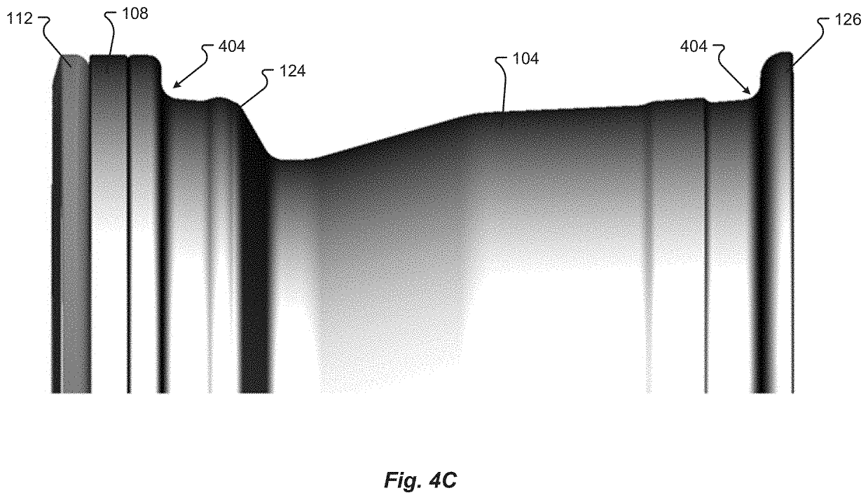

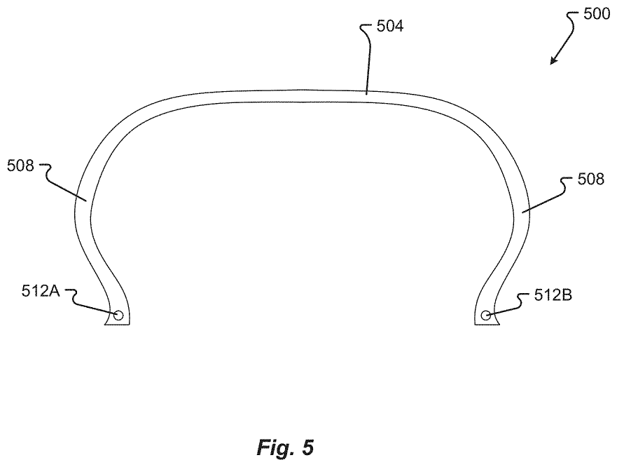

FIGS. 4A to 4C depict a beadlock assembly 400 in which the beadlock 112 has been secured to the wheel 104 with a plurality of bolts 132, with one bolt 132 extending through each of the apertures 128 of the beadlock 112 and threaded into each of the threaded apertures 116 of the wheel 104. The filler ring 108, which has a width substantially equal to the distance between the axially outer surface of the flange 124 and the axially inner surface of the flange 140 when the beadlock 112 is installed on the wheel 104, is held in its place around the circumferential ledge 136 by the beadlock 112. With both the beadlock 112 and the filler ring 108 installed on the wheel 104, the beads 512A, 512B of a tire 500 would be mounted at the mounting locations 404, inside the rim 126 and the flange 124 of the wheel 104.

Use of a filler ring 108 advantageously enables the beadlock 112 to be mounted to the wheel 104 when a tire 500 mounted thereon is fully inflated for on-road use, without violating applicable U.S. Department of Transportation regulations. Because the beadlock 112 can be mounted to the wheel 104 (with the filler ring 108 in place), the beadlock 112 may be used even when a vehicle to which the wheel 104 is operably connected is being used on normal roads and highways, beneficially increasing the aesthetic appeal of the vehicle and allowing the owner of the beadlock 112 to derive greater use and satisfaction from the beadlock 112.

Although the beadlock assemblies described herein comprise a beadlock 112 configured to be secured to a wheel 104 with a plurality of bolts, other fasteners and/or fastener systems may alternatively be used to secure the beadlock 112 to the wheel 104. For example, in some embodiments, the wheel 104 may comprise a plurality of threaded lugs protruding axially therefrom (e.g., with the lugs spaced at regular intervals and positioned a radial distance 106 from an axis 146 of the wheel 104), the apertures 128 of the beadlock 112 may be configured to receive the lugs, and a plurality of lug nuts may be threaded onto the lugs. Alternatively, the lugs may not be threaded but may each comprise a transverse aperture extending therethrough (perpendicular to an axis of the lug), and a cotter pin or cotter ring may be inserted through the transvere aperture of each lug to hold the beadlock 112 in place.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

A beadlock assembly according to one embodiment of the present disclosure comprises: a wheel comprising a first flange having a first diameter, and a circumferential ledge having a second diameter, the second diameter less than the first diameter; a filler ring having an inner diameter sized to allow the filler ring to fit around the circumferential ledge; and a beadlock comprising a second flange; wherein the filler ring is adapted to be secured between the first flange and the second flange when the beadlock is secured to the wheel.

Aspects of the foregoing beadlock assembly include: wherein the filler ring has an outer diameter substantially equal to the second diameter; wherein the beadlock has an outer diameter substantially equal to the second diameter; wherein the filler ring is hollow; wherein the beadlock comprises an inner circumferential ledge; wherein the inner circumferential ledge has a diameter substantially equal to the second diameter; wherein the wheel comprises a plurality of threaded apertures spaced at regular intervals at a first radial distance from an axis of the wheel; wherein the beadlock comprises a plurality of apertures spaced at regular intervals at a first radial distance from an axis of the beadlock; wherein the beadlock is configured to be removably secured to the wheel with a plurality of bolts; wherein the beadlock is made at least in part of metal and the filler ring is made at least in part of plastic.

A beadlock assembly according to another embodiment of the present disclosure comprises: a filler ring having an inner circumference adapted to fit around a circumferential ledge of a wheel; and a beadlock comprising a plurality of apertures spaced at regular intervals and positioned a first radial distance from an axis of the beadlock, the beadlock configured to be removably secured to the wheel; wherein when the filler ring is positioned around the circumferential ledge, and the beadlock is secured to the wheel, the beadlock secures the filler ring to the wheel.

Aspects of the foregoing beadlock assembly include: wherein filler ring has an outer diameter substantially similar to an outer diameter of the beadlock; wherein the beadlock is manufactured of metal; wherein the beadlock comprises a metallic finish; wherein the filler ring is manufactured of plastic; wherein the filler ring is manufactured of metal; and wherein the filler ring is hollow.

A wheel according to another embodiment of the present disclosure comprises: a flange defining a first rim and having a first diameter; a circumferential ledge extending axially from the first flange, the circumferential ledge having a second diameter less than the first diameter; a plurality of threaded apertures extending parallel to an axis of the wheel, the plurality of threaded apertures positioned in between the circumferential ledge and the axis and spaced at regular intervals.

Aspects of the foregoing wheel include: a beadlock secured to the wheel with a plurality of bolts, each of the plurality of bolts threaded into one of the plurality of threaded apertures; and a filler ring secured around the circumferential ledge and between the flange and the beadlock.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included a description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

I claim:

1. A beadlock assembly comprising:
a wheel comprising a first flange having a first diameter, and a circumferential ledge having a second diameter, the second diameter less than the first diameter;
a filler ring having an inner diameter sized to allow the filler ring to fit around the circumferential ledge; and
a beadlock comprising a second flange;
wherein the filler ring is adapted to be secured between the first flange and the second flange when the beadlock is secured to the wheel.

2. The beadlock assembly of claim 1, wherein the filler ring has an outer diameter substantially equal to the second diameter.

3. The beadlock assembly of claim 1, wherein the beadlock has an outer diameter substantially equal to the second diameter.

4. The beadlock assembly of claim 1, wherein the filler ring is hollow.

5. The beadlock assembly of claim 1, wherein the beadlock comprises an inner circumferential ledge.

6. The beadlock assembly of claim 5, wherein the inner circumferential ledge has a diameter substantially equal to the second diameter.

7. The beadlock assembly of claim 1, wherein the wheel comprises a plurality of threaded apertures spaced at regular intervals at a first radial distance from an axis of the wheel.

8. The beadlock assembly of claim 1, wherein the beadlock comprises a plurality of apertures spaced at regular intervals at a first radial distance from an axis of the beadlock.

9. The beadlock assembly of claim 1, wherein the beadlock is configured to be removably secured to the wheel with a plurality of bolts.

10. The beadlock assembly of claim 1, wherein the beadlock is made at least in part of metal and the filler ring is made at least in part of plastic.

11. A beadlock assembly, comprising:
a filler ring having an inner circumference adapted to fit around a circumferential ledge of a wheel; and
a beadlock comprising a plurality of apertures spaced at regular intervals and positioned a first radial distance from an axis of the beadlock, the beadlock configured to be removably secured to the wheel;
wherein when the filler ring is positioned around the circumferential ledge, and the beadlock is secured to the wheel, the beadlock secures the filler ring to the wheel.

12. The beadlock assembly of claim 11, wherein filler ring has an outer diameter substantially similar to an outer diameter of the beadlock.

13. The beadlock assembly of claim 11, wherein the beadlock is manufactured of metal.

14. The beadlock assembly of claim 11, wherein the beadlock comprises a metallic finish.

15. The beadlock assembly of claim 11, wherein the filler ring is manufactured of plastic.

16. The beadlock assembly of claim 11, wherein the filler ring is manufactured of metal.

17. The beadlock assembly of claim 11, wherein the filler ring is hollow.

18. A wheel comprising:
a flange defining a first rim and having a first diameter;
a circumferential ledge extending axially from the first flange, the circumferential ledge having a second diameter less than the first diameter;
a plurality of threaded apertures extending parallel to an axis of the wheel, the plurality of threaded apertures positioned in between the circumferential ledge and the axis and spaced at regular intervals.

19. The wheel of claim 18, further comprising a beadlock secured to the wheel with a plurality of bolts, each of the plurality of bolts threaded into one of the plurality of threaded apertures.

20. The wheel of claim 19, further comprising a filler ring secured around the circumferential ledge and between the flange and the beadlock.
